(19) United States
(12) Patent Application Publication
(10) Pub. No.: US 2022/0001476 A1
(43) Pub. Date: Jan. 6, 2022

(54) WIRE ARC ADDITIVE MANUFACTURING METHOD FOR HIGH-STRENGTH ALUMINUM ALLOY COMPONENT, EQUIPMENT AND PRODUCT

(71) Applicant: Wuhan University, Wuhan (CN)

(72) Inventors: Chen ZHANG, Wuhan (CN); Sheng LIU, Wuhan (CN); Junkai ZHU, Wuhan (CN); Dongbin ZHANG, Wuhan (CN)

(21) Appl. No.: 16/995,553

(22) Filed: Aug. 17, 2020

(30) Foreign Application Priority Data
Jul. 3, 2020 (CN) 2020106312727

(51) Int. Cl. B23K 9/04; B33Y 10/00; B33Y 30/00; B33Y 70/00; B23K 9/23; B23K 9/32; B23K 26/00; B23K 26/082; B23K 26/16; B23K 26/352; B23K 26/40; C22C 21/06; C22C 21/16

(52) U.S. Cl. CPC B23K 9/042; B23K 2103/10; B33Y 30/00; B33Y 70/00; B23K 9/232; B23K 9/328; B23K 26/0006; B23K 26/0093; B23K 26/082; B23K 26/16; B23K 26/352; B23K 26/40; C22C 21/06; C22C 21/16; B33Y 10/00

(57) ABSTRACT

The disclosure relates to the field of wire arc additive manufacturing, and specifically discloses a wire arc additive manufacturing method for a high-strength aluminum alloy component, equipment and a product. A high-strength aluminum alloy is modified by using a MXene nanomaterial, and wire arc additive manufacturing is performed by using the modified high-strength aluminum alloy as a raw material, and a nanosecond laser beam is applied during the wire arc additive manufacturing to achieve an enhanced arc cathode atomization cleanup function to remove impurities, thus obtaining a high-strength aluminum alloy component without defects. The disclosure can solve the problem of very difficult forming in wire arc additive manufacturing of a high-strength aluminum alloy, and also solve the problems of many pores, liability to crack and lots of impurities during additive manufacturing of the high-strength aluminum alloy, so that a high-strength aluminum alloy component without defects can be produced.

### BACKGROUND

### Technical Field

The disclosure relates to the field of wire arc additive manufacturing, and more specifically relates to a wire arc additive manufacturing method for a high-strength aluminum alloy component, equipment and a product.

### Description of Related Art

With continuous innovations and developments in the fields of aerospace, rail transit, new energy automobiles and the like, the demand for a high speed, a high range and low energy consumption of vehicles is increasing, and synchronous strengthening and lightweighting of structures has become one of important research subjects. A high-strength aluminum alloy has high strength, toughness and corrosion resistance, and a lower cost, and is an ideal lightweight material. In addition to using lightweight materials, overall structural optimization and integrated forming are also important methods for lightweighting. Previous studies have shown that the weight of a complex structure can be reduced by more than 30% in the case where integral forming is performed by additive manufacturing after topological optimization. Therefore, large-size high-strength aluminum alloy additive manufacturing technology has broad prospects for applications in lightweighting.

At present, additive manufacturing technologies suitable for components mainly include laser cladding forming and wire arc additive manufacturing (WAAM). WAAM originates from gas metal arc welding (GMAW) process in which an electric arc forms between a consumable wire electrode and the workpiece metals, and has a low cost and an extremely high deposition speed, which can reach 10 kg/h, and is the best technology for additive manufacturing of large-sized workpieces. However, due to shortcomings such as high porosity tendency, high crack sensitivity and reduced mechanical properties after welding, no breakthrough has yet been achieved in the WAAM technology of high-strength aluminum alloys. High-strength aluminum alloys contain a large amount of active elements such as Zn, Mg, Li, and Sc, which are prone to oxidation, evaporation, segregation, and cracking during solidification, and extremely high in defect sensitivity, and thus are recognized as difficult-to-weld materials. In addition, during the WAAM process, re-melting of a deposition layer containing surface impurities can increase impurities in a molten pool, and multiple thermal cycles causes stress accumulation, thereby increasing the cracking tendency in a heat affected zone, thus further increasing the forming difficulty of a high-strength aluminum alloy.

Therefore, researches and designs are urgently needed in this field to develop an additive manufacturing technology suitable for a high-strength aluminum alloy component, so as to reduce the forming difficulty of a high-strength aluminum alloy, and also solve the problems of many pores, liability to crack and lots of impurities in the additive manufacturing process of the high-strength aluminum alloy, thereby making a full use of the advantages of the high-strength aluminum alloy and the additive manufacturing technology in lightweighting.

### SUMMARY

In view of the above-mentioned drawbacks or improvement needs, the disclosure provides a wire arc additive manufacturing method for a high-strength aluminum alloy component, equipment and a product. A high-strength aluminum alloy is modified by mixing a MXene nanomaterial (which is a family of two-dimensional transition metal carbides, carbonitrides and nitrides), and a nanosecond pulse laser beam is applied during the wire arc additive manufacturing, to solve the problem of very difficult forming in wire arc additive manufacturing of a high-strength aluminum alloy, and also solve the problems of many pores, liability to crack and lots of impurities in the additive manufacturing process of the high-strength aluminum alloy, so that a high-strength aluminum alloy component without defects can be produced.

To achieve the above objective, according to an aspect of the disclosure, a wire arc additive manufacturing method for a high-strength aluminum alloy component is provided, in which a high-strength aluminum alloy is modified by mixing a MXene nanomaterial, and wire arc additive manufacturing is performed by using the modified high-strength aluminum alloy as a raw material, and a nanosecond laser beam is applied during the wire arc additive manufacturing to not only realize laser cleaning but also achieve an enhanced arc cathode atomization cleanup function (a cleaning function of the arc cathode obtained by an impact effect of positive ions on cathode) to remove impurities, thus obtaining a high-strength aluminum alloy component without defects.

Through the above concept, the disclosure can achieve cleaning of impurities and control of crystalline grains during the manufacturing process, thereby implementing the high-strength aluminum alloy WAAM with low porosity and few cracks.

Further preferably, the wire arc additive manufacturing method for a high-strength aluminum alloy component includes the following steps:

S1: mixing a high-strength aluminum alloy with a MXene nanomaterial to obtain a MXene-modified high-strength aluminum alloy filler wire;

S2: conveying the MXene-modified high-strength aluminum alloy filler wire to a specified position and performing arc starting to form a molten pool, and at the same time providing a nanosecond pulse laser beam for scanning movement to irradiate an arc cathode atomization area at a front end of the molten pool, to achieve an enhanced cathode atomization cleanup effect; and

S3: moving the MXene-modified high-strength aluminum alloy filler wire along a specified path to perform wire arc additive manufacturing, and during the process, adjusting the nanosecond pulse laser beam in real time to ensure that the beam is always irradiated on the arc cathode atomization area at the front end of the molten pool, thus obtaining a high-strength aluminum alloy component without defects.

Further preferably, amass ratio of the high-strength aluminum alloy to the MXene nanomaterial is (99.5-80):(0.5-20).

Further preferably, the nanosecond pulse laser beam has a power designed to be 50 W-1000 W, preferably 100 W-500 W, a laser pulse width of 0.1-1000 ns, preferably 1-500 ns, and a scanning speed of the nanosecond pulse laser beam of 0.1 m/s-10 m/s, preferably 0.5 m/s-2 m/s, and a scanning area of a nanosecond pulse laser beam spot is larger than the arc cathode atomization area at the front end of the molten pool.

Further preferably, the MXene nanomaterial is preferably of Mₙ₊₁Xₙ type, wherein M is one or more of Ti, Mo, V, Nb and W, and X is C or N.

Further preferably, in step S3, the position of the nanosecond pulse laser beam is adjusted by monitoring the position of the molten pool in real time, so that the beam is always irradiated on the arc cathode atomization area at the front end of the molten pool.

According to a second aspect of the disclosure, a wire arc additive manufacturing method for a 7XXXseries high-strength aluminum alloy component is provided, including the following steps:

S1: mixing a 7XXX series high-strength aluminum alloy with a MXene nanomaterial at a mass ratio of (99-98):(1-2) to obtain a MXene-modified 7XXX series high-strength aluminum alloy filler wire;

S2: conveying the MXene-modified 7XXX series high-strength aluminum alloy filler wire to a specified position and performing arc starting to form a molten pool, and at the same time providing a nanosecond pulse laser beam with a power of 100 W-200 W, a pulse width of 100 ns-200 ns, and a scanning speed of 2 m/s-4 m/s to irradiate an arc cathode atomization area at a front end of the molten pool to achieve an enhanced cathode atomization cleanup effect; and

S3: moving the MXene-modified 7XXX series high-strength aluminum alloy filler wire along a specified path to perform wire arc additive manufacturing, and during the process, adjusting the nanosecond pulse laser beam in real time to always irradiate the arc cathode atomization area at the front end of the molten pool, thus obtaining a 7XXX series high-strength aluminum alloy component without defects.

Further preferably, in step S3, a wire arc additive manufacturing process requires a dry extension of the filler wire of 10 mm-15 mm, a wire feed rate of 4 m/s-6 m/s, a depositing speed of 0.3 m/s-0.8 m/s, an arc current of 50 A-200 A, an arc voltage of 10V-30V, a gas flow rate of 20 L/min-30 L/min, a single-pass width of 5 mm-10 mm, and a single-layer height of 0.5 mm-2 mm.

According to a third aspect of the disclosure, a 7XXXseries aluminum alloy component is provided, which is manufactured by the method.

According to a fourth aspect of the disclosure, wire arc additive manufacturing equipment for a high-strength aluminum alloy component is provided, including an electric arc depositing device, a nanosecond pulse laser device, and a molten pool monitoring device, wherein the electric arc depositing device is used for conveying a MXene-modified high-strength aluminum alloy filler wire and performing wire arc additive manufacturing; the nanosecond pulse laser device is used for providing a nanosecond pulse laser beam to irradiate an arc cathode atomization area at a front end of the molten pool; and the molten pool monitoring device is used for monitoring the position of the molten pool in real time, and based on monitored data, adjusting the nanosecond pulse laser beam to always irradiate the arc cathode atomization area at the front end of the molten pool.

Generally, compared with the prior art, the above technical solutions conceived by the disclosure mainly have the following technical advantages:

1. The disclosure proposes for the first time the use of a MXene nanomaterial to modify a high-strength aluminum alloy to refine crystalline grains, thereby suppressing the generation of cracks, and proposes applying a nanosecond pulse laser beam during wire arc additive manufacturing to achieve an enhanced arc cathode atomization cleanup effect and effectively remove impurities, especially hydrogen-containing impurities, thereby suppressing the generation of pores, which greatly reduces the forming difficulty in wire arc additive manufacturing of the high-strength aluminum alloy and solves the difficult problem that the high-strength aluminum alloy is difficult to weld, so that high-quality and high-efficiency wire arc additive manufacturing of the high-strength aluminum alloy is possible, and thus the advantages of the high-strength aluminum alloy and the additive manufacturing technology in lightweighting can be made full use.

2. The disclosure proposes the use of a MXene nanomaterial to modify a high-strength aluminum alloy. The MXene material not only can be used as a nucleating agent to control dendrite growth on the solid-liquid surface of the molten pool and refine crystalline grains, thereby suppressing the generation of cracks, but also can absorb some impurities, thereby suppressing the generation of pores. In addition, the material can also be used as a secondary strengthening phase to improve the strength properties of the aluminum alloy.

3. The disclosure proposes applying a nanosecond pulse laser beam during wire arc additive manufacturing. The nanosecond pulse laser beam not only can directly remove impurities on the matrix surface, but also can combine with the arc cathode atomization cleanup of the wire arc additive manufacturing to achieve an enhanced composite cleaning effect, so that the impurity removal ability is further improved. In addition, the nanosecond pulse laser can also form a strong conductive channel in the arc, has the ability to change arc characteristics, and can optimize the arc characteristics, improve the melt flow behavior, and inhibit agglomeration, thereby improving the structural component uniformity of the aluminum alloy product, and ultimately improving the performance of the aluminum alloy product.

4. The disclosure also researches and designs a ratio of the high-strength aluminum alloy to the MXene nanomaterial to obtain a suitable ratio. Specifically, the mass ratio is designed to be (99.5-80):(0.5-20), preferably (99-90): (1-10); and heterogeneous nucleation in a solidification process can be achieved at the above mass ratio, thereby eventually inhibiting cracks, refining crystalline grains and promoting second phase strengthening. The mechanism of the second phase strengthening is that the second phase particles impede the movement of dislocations throughout the lattice. The MXene nanomaterial is the second phase particles.

5. The disclosure also researches and designs a specific process of the nanosecond pulse laser beam to obtain a better process. Specifically, the nanosecond pulse laser beam has a power designed to be 50 W-1000 W, preferably 100 W-500 W, a laser pulse width designed to be 0.1-1000 ns, preferably 1-500 ns, and a scanning speed designed to be 0.1 m/s-10 m/s, preferably 0.5 m/s-2 m/s, so that the nanosecond pulse laser has a stronger ability to excite impurities, and the hybrid cleaning effect after combination with the arc cathode atomization on the surface of the deposited layer is more obvious.

6. The disclosure also proposes specific manufacturing steps and process for the specific object of the 7XXX series high-strength aluminum alloy, and can produce a 7XXX series high-strength aluminum alloy component with high strength and toughness and without cracks and pores, such as aluminum alloys 7075 or 7050.

7. In addition, the disclosure also provides associated equipment, various components of which mutually cooperate and coordinate to ensure that the wire arc additive manufacturing of the high-strength aluminum alloy component is carried out effectively and reliably.

### BRIEF DESCRIPTION OF THE DRAWINGS

FIG. 1 is a flow diagram of a wire arc additive manufacturing method for a high-strength aluminum alloy component provided by an embodiment of the disclosure; and

FIG. 2 is a schematic structural diagram of hybrid laser cleaning-WAAM equipment for a high-strength aluminum alloy component provided by an embodiment of the disclosure.

FIG. 3 is some aluminum alloy components manufactured by the hybrid laser cleaning-WAAM equipment and the MXene-modified7075 filler wire.

In all drawings, same reference numerals are used to denote same elements or structures:

1—computer, 2—electric arc power source, 3—wire feed unit, 4—depositing torch, 5—filler wire, 6—shielding gas unit, 7—laser scanning head, 8—nanosecond laser emitter, 9—molten pool monitoring device, 10—molten pool, 11—high-strength aluminum alloy product, 12—workpiece carrying platform, 13—depositing torch movement unit, 14—arc cathode atomization area, 15—scanning laser beam, 16—arc.

### DESCRIPTION OF THE EMBODIMENTS

To make the objectives, technical solutions and advantages of the disclosure clearer, the disclosure will be further described in detail below in conjunction with the accompanying drawings and embodiments. It should be understood that the specific embodiments described herein are only used for explaining the disclosure and are not intended to limit the disclosure. In addition, technical features involved in implementation modes of the disclosure described below can be combined with each other so long as they do not conflict with each other.

An existing high-strength aluminum alloy component produced by wire arc additive manufacturing mainly has the problems of many pores and liability to crack in a wire arc additive manufacturing process. It has been found through research that the mechanism of generating the pores is as follows: when an aluminum alloy solidifies, hydrogen is evolved in hydrogen bubbles at a solid-liquid interface. If the bubbles are blocked during discharge, pores are formed after the aluminum alloy solidifies. The more the hydrogen-containing impurities are, the higher the porosity tendency is. Therefore, to eliminate the pores, the hydrogen-containing impurities need to be controlled effectively. The mechanism of generating cracks is as follows: when dendrite arms are long at the solid-liquid interface, and intercrystalline pores cannot be timely refilled by a melt liquid, cracks are generated, so crystalline grain sizes and structures need to be controlled effectively. Thus, reducing hydrogen-containing impurities in a molten pool, controlling crystalline grain growth, and optimizing the alloy structure are the keys to inhibiting pores and cracks and improving mechanical properties.

Based on the above research, the disclosure proposes a wire arc additive manufacturing method for a high-strength aluminum alloy component, in which a high-strength aluminum alloy is modified by using a MXene nanomaterial, then wire arc additive manufacturing is performed by using the modified high-strength aluminum alloy as a raw material, and a nanosecond laser beam is applied during the wire arc additive manufacturing to achieve an enhanced cathode atomization cleanup function to remove impurities, thus obtaining a high-strength aluminum alloy component without pores and cracks.

Firstly, the disclosure proposes using the MXene nanomaterial to modify the high-strength aluminum alloy, that is, adding the MXene nanomaterial to the high-strength aluminum alloy to produce the modified high-strength aluminum alloy. The MXene material has good surface wettability and high temperature stability, which can effectively improve the nucleation effect and ensure dendrite refinement. Adding the MXene as a nucleating agent can control dendrite growth on the solid-liquid surface of the molten pool, refine crystaline grains and absorb impurities, thereby inhibiting the generation of cracks and pores. Furthermore, the MXene may be used as a secondary strengthening phase to improve the performance of the aluminum alloy, thereby obtaining a high-performance nanocomposite aluminum alloy.

In the disclosure, the MXene nanomaterial is preferably of Mₙ₊₁Xₙ type, wherein M is one or more of Ti, Mo, V, Nb and W, and X is C or N, such as Ti₂C, Ti₃C₂, (Cr₂Ti)C₂, Ti₃(C,N)₂, and (Nb,V)C₂. Further preferably, Ti₃C₂ is used as a modifier for the WAAM of the high-strength aluminum alloy, and has the following advantages: 1) outer layer elements are mainly titanium atoms, and thus similar to other titanium-based nucleating agents, it has relatively good molten metal surface wettability and a good nucleation effect, easily reacts with aluminum, and forms a more excellent bonding interface; 2) Ti₃C₂ has the highest Young's modulus (up to 0.33±0.03 TPa) and high bending stiffness (up to 49.5 eV) among two-dimensional materials, which is conducive to improving strength and toughness; and 3) it has a multi-layer structure with a high specific surface area and strong adsorption capacity, so that —OH, —O and other functional groups are easily formed on the surface layer, which is conducive to the absorption of impurity elements in the molten pool.

Secondly, the disclosure proposes applying the nanosecond laser beams during the wire arc additive manufacturing process, to scan the surface of the material by using the nanosecond pulse laser, so that after absorbing laser energy, the impurities on the material surface quickly vaporize or expand by heat instantly, at the same time particle vibration is caused, and finally, the impurities drop from the material matrix surface to achieve the effect of cleaning the surface without damaging the matrix. The nanosecond pulse laser not only can remove impurities directly, but also can synchronously combine with arc cathode spots on the surface of a deposited layer to achieve an enhanced cathode atomization cleanup function and a hybrid cleaning effect. That is, the disclosure proposes a hybrid laser cleaning-WAAM manufacturing technology of a MXene-modified high-strength aluminum alloy, which is not a simple process superposition. The nanosecond pulse laser beam not only can remove impurities directly, but also can synchronously combine with the arc cathode spots to achieve an enhanced cathode cleanup function and a cleanup effect of 1+1>2; furthermore, the MXene is added as a nucleating agent to control the dendrite growth on the solid-liquid interface of the molten pool, inhibit cracks, refine crystalline grains, and provide a secondary strengthening phase, so that a high-performance nanocomposite high-strength aluminum alloy can be formed finally.

Based on the above design concept, the disclosure proposes specific operation steps of the wire arc additive manufacturing method for a high-strength aluminum alloy component, specifically including the following steps:

S1: a high-strength aluminum alloy is mixed with a MXene nanomaterial to obtain a MXene-modified high-strength aluminum alloy filler wire, wherein amass ratio of the high-strength aluminum alloy to the MXene nanomaterial is (99.5-80):(0.5-20), preferably (99-90): (1-10); and heterogeneous nucleation in a solidification process can be achieved at the above mass ratio, thereby eventually inhibiting cracks, refining crystalline grains and promoting second phase strengthening, so that both the strength and toughness of the finally produced material reach a high level, which is very conducive to form components with high mechanical properties.

S2: the MXene-modified high-strength aluminum alloy filler wire is conveyed and arc starting is performed to form a molten pool, wherein positive ions in the arc bombard a workpiece and the surface of the molten pool to form a circle of arc cathode atomization area around the molten pool to achieve an arc cathode atomization function, so that impurities on the workpiece and the surface of the molten pool can be removed; at that time, a nanosecond pulse laser for scanning movement can be provided in the arc cathode atomization area at a front end of the molten pool (an area where the workpiece is to be melted) so that the arc cathode atomization area at the front end of the molten pool is covered by a nanosecond pulse laser beam, thereby achieving not only the arc cathode atomization function but also a nanosecond pulse laser function at the front end of the molten pool, and the two functions can be combined to achieve an enhanced atomization cleanup function to effectively remove impurities at the front end of the molten pool, and ensure the production of the high-strength aluminum alloy component without defects. The nanosecond pulse laser beam has a power of 50 W-1000 W, preferably 100 W-500 W, and a scanning speed of 0.1 m/s-10 m/s, preferably 0.5 m/s-2 m/s, and a scanning area of a nanosecond pulse laser beam spot is larger than the arc cathode atomization area at the front end of the molten pool to ensure that the nanosecond pulse laser beam covers the cathode atomization area at the front end of the molten pool.

S3: the MXene-modified high-strength aluminum alloy filler wire is moved along a specified path to perform wire arc additive manufacturing, and during the process, the nanosecond pulse laser beam is adjusted in real time to ensure that the beam is always irradiated on the arc cathode atomization area at the front end of the molten pool, thus obtaining the high-strength aluminum alloy component without defects (e.g., without pores and cracks).

The disclosure is applicable to any high-strength aluminum alloys, such as Al—Zn—Mg—Cu, Al—Mg—Sc, Al—Mg, Al—Cu, Al—Li, Al—Sc and other aluminum alloys, especially applicable to a 7XXX-series (Al—Zn—Mg—Cu) high-strength aluminum alloy. As a 7XXX-series aluminum alloy contains a large amount of active elements such as Zn and Mg, which are prone to oxidation, evaporation and segregation during solidification, and extremely high in defect sensitivity, forming a defect-free part is very difficult by using a conventional wire arc additive manufacturing method. With the disclosure, a 7XXX series high-strength aluminum alloy component can be effectively formed, and pores and cracks in the component can be reduced.

For the 7XXX series high-strength aluminum alloy as a special object, a manufacturing process applicable to the object is specifically designed in the disclosure, specifically including the following steps:

S1: a 7XXX series high-strength aluminum alloy is mixed with a MXene nanomaterial at a mass ratio of (99-98):(1-2) to obtain a MXene-modified 7XXX series high-strength aluminum alloy filler wire;

S2: the MXene-modified 7XXX series high-strength aluminum alloy filler wire is conveyed at a speed of 5 m/min and arc starting is performed to form a molten pool, and at the same time a nanosecond pulse laser beam with a power of 100 W-200 W, a pulse width of 100 ns-200 ns and a scanning speed of 2 m/s-4 m/s is provided to irradiate an arc cathode atomization area at a front end of the molten pool to achieve an enhanced cathode atomization cleanup effect; and

S3: the MXene-modified 7XXX series high-strength aluminum alloy filler wire is moved along a specified path to perform wire arc additive manufacturing, and during the process, the nanosecond pulse laser beam is adjusted in real time to ensure that the beam is always irradiated on the arc cathode atomization area at the front end of the molten pool, thus obtaining the 7XXX series high-strength aluminum alloy component without defects (without pores and cracks).

The disclosure also researches the specific wire arc additive manufacturing process of the 7XXX series high-strength aluminum alloy to obtain a better process. Specifically, a depositing torch is vertically arranged, with a dry extension of the filler wire of 10 mm-15 mm, a wire feed rate of 4 m/s-6 m/s, a depositing speed of 0.3 m/s-0.8 m/s, an arc current of 50 A-200 A, an arc voltage of 10V-30V, a gas flow rate of 20 L/min-30 L/min, a single-pass width of 5 mm-10 mm, and a single-layer height of 0.5 mm-2 mm.

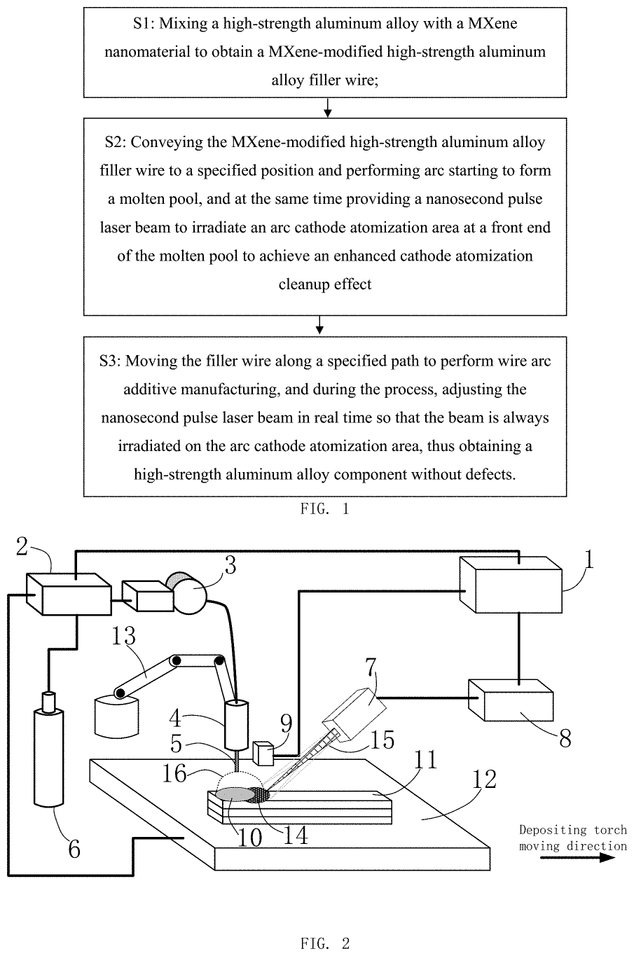

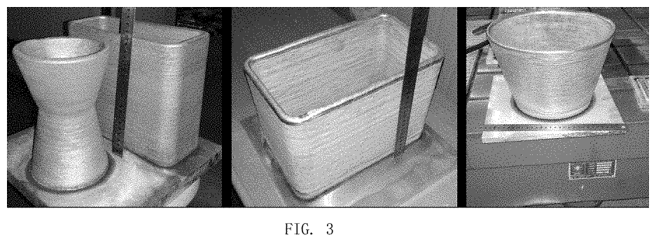

In addition, the disclosure further provides equipment applicable to the above-mentioned manufacturing method, as shown in FIG. 2, specifically including an electric arc depositing device (including electric arc power source 2, wire feed unit 3 and depositing torch 4), a nanosecond pulse laser device (including laser scanning head 7 and nanosecond laser emitter 8), and a molten pool monitoring device 9, wherein the electric arc depositing device is used for conveying a MXene-modified high-strength aluminum alloy filler wire and performing wire arc additive manufacturing; the nanosecond pulse laser device is used for providing a nanosecond pulse laser beam to irradiate an arc cathode atomization area at a front end of the molten pool; and the molten pool monitoring device is used for monitoring the position of the molten pool in real time, and based on monitored data, adjusting the nanosecond pulse laser beam to always irradiate the arc cathode atomization area at the front end of the molten pool.

The arc additive manufacture device includes an electric arc power source 2, a wire feed unit 3, a depositing torch movement unit 13, a depositing torch 4 and a shielding gas unit 6, wherein the electric arc power source 2 is used for controlling the wire feed unit 3 to feed a filler wire 5 to the depositing torch 4 at a predetermined speed, and for controlling the depositing torch movement unit 13 to drive the depositing torch 4 to move along a specified path; and the shielding gas unit 6 (such as a shielding gas cylinder) is connected to the depositing torch 4 and provides a protective gas, such as high-purity argon gas to an electric arc depositing machine during the depositing process. The specific path is constructed by a computer 1 according to a workpiece to be formed by using a 3D model and slicing software to obtain forming path parameters corresponding to each layer, which is the prior art and is not be described here. After the forming path parameters of each layer are obtained, the parameters are input into the electric arc power source to control the depositing torch to move along the specified path.

The nanosecond pulse laser device is specifically a laser scanning head 7 and a nanosecond laser emitter 8, the laser scanning head 7 controls the movement of laser beam and the nanosecond laser emitter 8 is used for emitting nanosecond pulse laser. They are connected with a fiber which transfers the laser beam.

As the position of the molten pool changes with the movement of the depositing torch, the molten pool monitoring device 9 is provided, which is arranged beside the depositing torch 4 to monitor the position of the molten pool in real time and feed the monitored data back to the computer 1, and the computer 1 controls the laser scanning head 7 based on the monitored data, to adjust the position of the nanosecond pulse laser beam so that the beam is always emitted to the arc cathode atomization area at the front end of the molten pool.

In actual manufacturing, a workpiece carrying platform 12 is arranged below the depositing torch 4, and the wire feed unit 3 feeds the filler wire 5 to the depositing torch 4 at a predetermined speed and arc 16 starting between the wire and the workpiece is performed to carry out wire arc additive manufacturing, and the shielding gas unit 6 provides a shielding gas to prevent oxidation and contamination of the workpiece. After the start of the manufacturing, the depositing torch 4 drives the filler wires to move along a predetermined path, and the laser scanning head 7 emits a nanosecond pulse laser beam 15 to irradiate the arc cathode atomization area 14 at the front end of the molten pool, and the molten pool monitoring device 9 beside the depositing torch 4 monitors the position of the molten pool 10 in real time, and adjusts an emergent direction and a laser spot size of the laser scanning head 7 according to the monitored position of the molten pool, so that the nanosecond pulse laser beam is always irradiated on the arc cathode atomization zone at the front end of the molten pool, to achieve the purpose of removing impurities. With the formation of an aluminum alloy deposition layer containing refined isometric crystals with MXene particles, each layer is stacked to finally form a defect-free MXene-modified high-strength aluminum alloy product 11. That is, firstly, a first layer is deposited on the workpiece carrying platform 12 (substrate), then the next layer is deposited on the deposited layer, and so on, to accomplish the wire arc additive manufacturing of the entire workpiece.

Embodiments of the disclosure are as follows:

### Embodiment 1

In the embodiment, a 7075 aluminum alloy component is used as an example to describe the manufacturing method of the disclosure in detail, wherein Ti₃C₂ is used as the MXene, and the method specifically includes the following steps:

S1: a 7075 aluminum alloy is mixed with Ti₃C₂ powder to obtain a Ti₃C₂-MXene-modified high-strength aluminum alloy filler wire with a diameter of 1.2 mm, wherein amass ratio of the high-strength aluminum alloy powder to the MXene nanomaterial is 98:2;

S2: the MXene-modified high-strength aluminum alloy filler wire is conveyed and arc starting is performed to form a molten pool, and at the same time a nanosecond pulse laser beam is provided to irradiate an arc cathode atomization area at a front end of the molten pool, wherein the nanosecond pulse laser has a power of 100 W, a laser pulse width of 100 ns, a scanning speed of 2 m/s, and a beam spot diameter of 0.1 mm; and

S3: the MXene-modified high-strength aluminum alloy filler wire is moved along a specified path to perform wire arc additive manufacturing, and the position of the nanosecond pulse laser beam is adjusted in real time during the wire arc additive manufacturing, so that the beam is always irradiated on the arc cathode atomization area at the front end of the molten pool, wherein the wire arc additive manufacturing process requires a dry extension of the filler wire of 15 mm, a wire feed rate of 6 m/min, a depositing speed of 0.8 m/min, an arc current of 95 A, an arc voltage of 13.3V, a gas flow rate of 30 L/min, a single-pass width of 5.3 mm, and a single-layer height of 2 mm, thus finally producing a high-strength aluminum alloy component without defects.

### Embodiment 2

In the embodiment, a 7050 aluminum alloy component is used as an example to describe the manufacturing method of the disclosure in detail, wherein Ti₃C₂ is used as the MXene, and the method specifically includes the following steps:

S1: a 7050 aluminum alloy is mixed with a Ti₃C₂ material to obtain a Ti₃C₂-MXene-modified high-strength aluminum alloy filler wire with a diameter of 1.2 mm, wherein amass ratio of the high-strength aluminum alloy powder to the MXene nanomaterial is 99:1;

S2: the MXene-modified high-strength aluminum alloy filler wire is conveyed and arc starting is performed to form a molten pool, and at the same time a nanosecond pulse laser beam is provided to irradiate an arc cathode atomization area at a front end of the molten pool, wherein the nanosecond pulse laser has a power of 200 W, a laser pulse width of 200 ns, a scanning speed of 4 m/s, and a beam spot diameter of 0.2 mm; and

S3: the MXene-modified high-strength aluminum alloy filler wire is moved along a specified path to perform wire arc additive manufacturing, and the position of the nanosecond pulse laser beam is adjusted in real time during the wire arc additive manufacturing, so that the beam is always irradiated on the arc cathode atomization area at the front end of the molten pool, wherein the wire arc additive manufacturing process requires a dry extension of the filler wire of 10 mm, a wire feed rate of 5 m/min, a depositing speed of 0.6 m/min, an arc current of 78 A, an arc voltage of 12.5 V, a gas flow rate of 30 L/min, a single-pass width of 5 mm, and a single-layer height of 1.5 mm, thus finally producing a high-strength aluminum alloy component without defects.

### Embodiment 3

In the embodiment, a 2319 aluminum alloy component is used as an example to describe the manufacturing method of the disclosure in detail, wherein Ti₂C is used as the MXene, and the method specifically includes the following steps:

S1: a 2319 aluminum alloy is mixed with Ti₂C powder to obtain a Ti₂C-MXene-modified high-strength aluminum alloy filler wire with a diameter of 1.5 mm, wherein amass ratio of the high-strength aluminum alloy to the MXene nanomaterial is 98.5:1.5;

S2: the MXene-modified high-strength aluminum alloy filler wire is conveyed and arc starting is performed to form a molten pool, and at the same time a nanosecond pulse laser beam is provided to irradiate an arc cathode atomization area at a front end of the molten pool, wherein the nanosecond pulse laser has a power of 50 W, a laser pulse width of 0.1 ns, a scanning speed of 10 m/s, and a beam spot diameter of 0.15 mm; and

S3: the MXene-modified high-strength aluminum alloy filler wire is moved along a specified path to perform wire arc additive manufacturing, and the position of the nanosecond pulse laser beam is adjusted in real time during the wire arc additive manufacturing, so that the beam is always irradiated on the arc cathode atomization area at the front end of the molten pool, wherein the wire arc additive manufacturing process requires a dry extension of the filler wire of 14 mm, a wire feed rate of 5.5 m/min, a depositing speed of 0.8 m/min, an arc current of 150 A, an arc voltage of 25 V, a gas flow rate of 20 L/min, a single-pass width of 8 mm, and a single-layer height of 1.6 mm, thus finally producing a high-strength aluminum alloy component without defects.

### Embodiment 4

In the embodiment, an Al—Mg—Sc aluminum alloy component is used as an example to describe the manufacturing method of the disclosure in detail, wherein Ti₂C is used as the MXene, and the method specifically includes the following steps:

S1: an Al—Mg—Sc aluminum alloy is mixed with Ti₂C powder to obtain a Ti₂C-MXene-modified high-strength aluminum alloy filler wire with a diameter of 1.2 mm, wherein amass ratio of the high-strength aluminum alloy to the MXene nanomaterial is 99.5:0.5;

S2: the MXene-modified high-strength aluminum alloy filler wire is conveyed and arc starting is performed to form a molten pool, and at the same time a nanosecond pulse laser beam is provided to irradiate an arc cathode atomization area at a front end of the molten pool, wherein the nanosecond pulse laser has a power of 500 W, a laser pulse width of 600 ns, a scanning speed of 5 m/s, and a beam spot diameter of 0.1 mm; and

S3: the MXene-modified high-strength aluminum alloy filler wire is moved along a specified path to perform wire arc additive manufacturing, and the position of the nanosecond pulse laser beam is adjusted in real time during the wire arc additive manufacturing, so that the beam is always irradiated on the arc cathode atomization area at the front end of the molten pool, wherein the wire arc additive manufacturing process requires a dry extension of the filler wire of 12 mm, a wire feed rate of 4.2 m/min, a depositing speed of 0.4 m/min, an arc current of 63 A,anarc voltage of 10 V, a gas flow rate of 25 L/min, a single-pass width of 6 mm, and a single-layer height of 1.2 mm, thus finally producing a high-strength aluminum alloy component without defects.

The wire arc additive manufacturing method for a high-strength aluminum alloy component provided by the disclosure is a hybrid laser cleaning-WAAM manufacturing technology of a MXene-modified high-strength aluminum alloy, in which the MXene is added as a nucleating agent to control crystalline grain growth, and the nanosecond pulse laser and the arc are used in combination to remove impurities to achieve the purpose of reducing impurities and controlling crystalline grain growth during the WAAM manufacturing process, thereby obtaining a high-strength aluminum alloy component without defects (i.e. with low porosity and few cracks), especially a large high-strength aluminum alloy component.

It is easily understood by those skilled in the art that described above are only preferred embodiment of the disclosure, which are not intended to limit the disclosure, and any modifications, equivalent substitutions and improvement made within the spirit and principle of the disclosure should be encompassed within the protection scope of the disclosure.

What is claimed is:

1. A wire arc additive manufacturing method for a high-strength aluminum alloy component, comprising:
modifying a high-strength aluminum alloy by using a MXene nanomaterial;
using the modified high-strength aluminum alloy as raw material for wire arc additive manufacturing;
applying a nanosecond laser beam when manufacturing to achieve an enhanced arc cathode atomization cleanup function to remove impurities, and
obtaining a high-strength aluminum alloy component without defects.

2. The wire arc additive manufacturing method for a high-strength aluminum alloy component according to claim 1, further comprising:
S1: mixing the high-strength aluminum alloy with the MXene nanomaterial to obtain a MXene-modified high-strength aluminum alloy filler wire;
S2: conveying the MXene-modified high-strength aluminum alloy filler wire to a specified position and performing arc starting to form a molten pool, and at the same time providing a nanosecond pulse laser beam for scanning movement to irradiate an arc cathode atomization area at a front end of the molten pool, thereby achieving an enhanced cathode atomization cleanup effect; and
S3: moving the MXene-modified high-strength aluminum alloy filler wire along a specified path to perform wire arc additive manufacturing, and during the process, adjusting the nanosecond pulse laser beam in real time to ensure that the beam is always irradiated on the arc cathode atomization area at the front end of the molten pool, thus obtaining a high-strength aluminum alloy component without defects.

3. The wire arc additive manufacturing method of a high-strength aluminum alloy component according to claim 2, wherein amass ratio of the high-strength aluminum alloy to the MXene nanomaterial is (99-90): (1-10).

4. The wire arc additive manufacturing method for a high-strength aluminum alloy component according to claim 2, wherein the nanosecond pulse laser beam has a power designed to be 100 W-500 W, a laser pulse width designed to be 1-500 ns, and a scanning speed designed to be 0.5 m/s-2 m/s, and
a scanning area of a laser beam spot is larger than the arc cathode atomization area at the front end of the molten pool.

5. The wire arc additive manufacturing method for a high-strength aluminum alloy component according to claim 3, wherein the nanosecond pulse laser beam has a power designed to be 100 W-500 W, a laser pulse width designed to be 1-500 ns, and a scanning speed designed to be 0.5 m/s-2 m/s, and
a scanning area of a laser beam spot is larger than the arc cathode atomization area at the front end of the molten pool.

6. The wire arc additive manufacturing method for a high-strength aluminum alloy component according to claim 2, wherein the MXene nanomaterial is preferably of Mₙ₊₁Xₙ type, wherein M is one or more of Ti, Mo, V, Nb and W, and X is C or N.

7. The wire arc additive manufacturing method for a high-strength aluminum alloy component according to claim 3, wherein the MXene nanomaterial is preferably of Mₙ₊₁Xₙ type, wherein M is one or more of Ti, Mo, V, Nb and W, and X is C or N.

8. The wire arc additive manufacturing method for a high-strength aluminum alloy component according to claim 4, wherein the MXene nanomaterial is preferably of Mₙ₊₁Xₙ type, wherein M is one or more of Ti, Mo, V, Nb and W, and X is C or N.

9. The wire arc additive manufacturing method for a high-strength aluminum alloy component according to claim 5, wherein the MXene nanomaterial is preferably of Mₙ₊₁Xₙ type, wherein M is one or more of Ti, Mo, V, Nb and W, and X is C or N.

10. The wire arc additive manufacturing method for a high-strength aluminum alloy component according to claim 2, wherein in step S3, the position of the nanosecond pulse laser beam is adjusted by monitoring the position of the molten pool in real time, so that the beam is always irradiated on the arc cathode atomization area at the front end of the molten pool.

11. The wire arc additive manufacturing method for a high-strength aluminum alloy component according to claim 3, wherein in step S3, the position of the nanosecond pulse laser beam is adjusted by monitoring the position of the molten pool in real time, so that the beam is always irradiated on the arc cathode atomization area at the front end of the molten pool.

12. The wire arc additive manufacturing method for a high-strength aluminum alloy component according to claim 4, wherein in step S3, the position of the nanosecond pulse laser beam is adjusted by monitoring the position of the molten pool in real time, so that the beam is always irradiated on the arc cathode atomization area at the front end of the molten pool.

13. The wire arc additive manufacturing method for a high-strength aluminum alloy component according to claim 5, wherein in step S3, the position of the nanosecond pulse laser beam is adjusted by monitoring the position of the molten pool in real time, so that the beam is always irradiated on the arc cathode atomization area at the front end of the molten pool.

14. The wire arc additive manufacturing method for a high-strength aluminum alloy component according to claim 6, wherein in step S3, the position of the nanosecond pulse laser beam is adjusted by monitoring the position of the molten pool in real time, so that the beam is always irradiated on the arc cathode atomization area at the front end of the molten pool.

15. The wire arc additive manufacturing method for a high-strength aluminum alloy component according to claim 7, wherein in step S3, the position of the nanosecond pulse laser beam is adjusted by monitoring the position of the molten pool in real time, so that the beam is always irradiated on the arc cathode atomization area at the front end of the molten pool.

16. A wire arc additive manufacturing method for a 7XXX series high-strength aluminum alloy component, comprising:
S1: mixing a 7XXX series high-strength aluminum alloy with a MXene nanomaterial at a mass ratio of (99-98):(1-2) to obtain a MXene-modified 7XXX series high-strength aluminum alloy filler wire;
S2: conveying the MXene-modified 7XXX series high-strength aluminum alloy filler wire to a specified position and performing arc starting to form a molten pool, and at the same time providing a nanosecond pulse laser beam with a power of 100 W-200 W, a pulse width of 100 ns-200 ns, and a scanning speed of 2 m/s-4 m/s to irradiate an arc cathode atomization area at a front end of the molten pool to achieve an enhanced cathode atomization cleanup effect; and
S3: moving the MXene-modified 7XXX series high-strength aluminum alloy filler wire along a specified path to perform wire arc additive manufacturing, and during the process, adjusting the nanosecond pulse laser beam in real time to always irradiate the arc cathode atomization area at the front end of the molten pool, thus obtaining a 7XXX series high-strength aluminum alloy component without defects.

17. The wire arc additive manufacturing method for a 7XXX series high-strength aluminum alloy component according to claim 16, wherein in step S3, a wire arc additive manufacturing process requires a dry extension of the filler wire of 10 mm-15 mm, a wire feed rate of 4 m/s-6 m/s, a depositing speed of 0.3 m/s-0.8 m/s, an arc current of 50 A-200 A, an arc voltage of 10V-30V, a gas flow rate of 20 L/min-30 L/min, a single-pass width of 5 mm-10 mm, and a single-layer height of 0.5 mm-2 mm.

18. A 7XXX series high-strength aluminum alloy component, manufactured by the method of claim 16.

19. A 7XXX series high-strength aluminum alloy component, manufactured by the method of claim 17.

20. A wire arc additive manufacturing equipment for a high-strength aluminum alloy component, comprising:
an electric arc depositing device;
a nanosecond pulse laser device; and
a molten pool monitoring device,
wherein the electric arc depositing device is configured to convey a MXene-modified high-strength aluminum alloy filler wire and to perform wire arc additive manufacturing;
the nanosecond pulse laser device is configured to provide a nanosecond pulse laser beam to irradiate an arc cathode atomization area at a front end of the molten pool; and
the molten pool monitoring device is configured to monitor the position of the molten pool in real time, and based on monitored data, to adjust the nanosecond pulse laser beam to always irradiate the arc cathode atomization area at the front end of the molten pool.
